(19) United States
(12) Patent Application Publication
(10) Pub. No.: US 2026/0212771 A1
(43) Pub. Date: Jul. 23, 2026

(54) METHOD AND APPARATUS FOR GENERATING VIRTUAL TEACHING SCENE, AND DEVICE AND STORAGE MEDIUM

(71) Applicant: Zhejiang Normal University, Jinhua (CN)

(72) Inventors: Jia Zhu, Jinhua (CN); Zhangze Chen, Jinhua (CN); Hanghui Guo, Jinhua (CN)

(21) Appl. No.: 19/224,729

(22) Filed: May 31, 2025

(30) Foreign Application Priority Data
Jan. 20, 2025 (CN) 2025100804326

(51) Int. Cl. G09B 5/02; G06T 15/08; G06T 15/20

(52) U.S. Cl. CPC G09B 5/02; G06T 15/08; G06T 15/20

(57) ABSTRACT

A method for generating a virtual teaching scene, including: extracting semantic features, visual features, and sampling features; mapping and classifying the above features to obtain rendering parameters; rendering shapes and surface textures of all objects contained in a virtual classroom in real-time using the rendering parameters to obtain three-dimensional (3D) teaching resources; and performing spatial layout encoding and scene hierarchical encoding on the 3D teaching resources individually to obtain spatial layout features and hierarchical spatial features, decoding the spatial layout features and the hierarchical spatial features to obtain geometric shapes and layout position parameters, and generating the virtual teaching scene based on the geometric shapes and the layout position parameters. The method can dynamically adjust the virtual teaching scene according to different teaching activities and scenes, thereby enhancing adaptability. It accurately describes spatial relationships between multiple objects in the 3D teaching resources, thereby improving accuracy of the virtual teaching scene.

### CROSS-REFERENCE TO RELATED APPLICATION

This application claims priority to Chinese Patent Application No. 202510080432.6, filed on Jan. 20, 2025, which is herein incorporated by reference in its entirety.

### TECHNICAL FIELD

The disclosure relates the field of data processing technologies, and more particularly to a method and an apparatus for generating a virtual teaching scene, and a device and a storage medium.

### BACKGROUND

With the rapid development of technology, the field of education is undergoing profound transformations. A virtual classroom, as a new type of teaching environment, has significant differences from a traditional classroom. It connects teachers and learners via digital platforms such as the Internet, enabling remote teaching and learning. Among its key components, virtual teaching scenes are the most important part for constructing the virtual classroom. Therefore, the accurate generation of the virtual teaching scenes is crucial for the precise construction of the virtual classroom.

Existing methods in the related art for generating the virtual teaching scenes primarily adopt three-dimensional (3D) reconstruction technology. 3D reconstruction is a multimedia technology widely used in computer-aided modeling and 3D animation, which utilizes the assistance of shape priors and shape inference capabilities to reconstruct 3D objects from single-view red, green and blue (RGB) images. In recent years, researchers have proposed various improved methods to enhance the accuracy and efficiency of reconstruction. Han et al. explores the use of deep learning technology to estimate 3D shapes from single or multiple RGB images, thereby to solve some of the challenges in this field. Sun et al. introduces an autoregressive point cloud generation model called Point Grow, which models 3D spatial distribution in a point-by-point manner to achieve diverse and realistic 3D shape generation. Wu et al. utilizes two-dimensional (2D) diffusion priors to generate 3D content from text, thereby improving the quality and detail of generated 3D models. A new method combining multiple noise estimation processes with pre-trained diffusion priors has also been proposed.

Although the existing methods in the related art for generating the virtual teaching scenes can accurately represent the corresponding teaching scenes, these teaching scenes are mostly static information with poor real-time and adaptability, making it difficult to dynamically adjust according to different teaching activities and scenes. In addition, when generating more complex teaching scenes, the above methods are difficult to accurately describe intricate spatial relationships between objects, resulting in significant deviations between final generated teaching scenes and reality.

### SUMMARY

The disclosure provides a method and an apparatus for generating a virtual teaching scene, and a device and a storage medium, which solves a problem that most of teaching scenes generated by existing virtual teaching scene generation methods in the related art are static information with poor real-time and adaptability, and it is difficult to accurately describe intricate spatial relationships when generating complex teaching scenes, resulting in significant deviations between final generated teaching scenes and reality.

In a first aspect, the disclosure provides a method for generating a virtual teaching scene, including:
performing feature extraction on text resources and image resources containing teaching scenes to obtain semantic features, visual features, and sampling features, where the sampling features include 3D positions and viewing directions of sampling points in the image resources, and the 3D positions and the viewing directions varying over time;
mapping and classifying the semantic features, the visual features, and the sampling features to obtain rendering parameters for the virtual teaching scene; and mapping the rendering parameters to a 3D space, and rendering shapes and surface textures of all objects contained in a virtual classroom in real time using the rendering parameters, thereby obtaining 3D teaching resources varying over time; and
performing spatial layout encoding and scene hierarchical encoding individually on the 3D teaching resources, thereby obtaining spatial layout features representing layout positions of the 3D teaching resources in a 3D scene and hierarchical spatial features representing dynamic evolutions of the 3D resources in the 3D scene; and decoding the spatial layout features and the hierarchical spatial features to obtain geometric shapes and layout position parameters of the 3D teaching resources, and generating the virtual teaching scene based on the geometric shapes and the layout position parameters of the 3D teaching resources.

In an embodiment, the method for generating the virtual teaching scene further includes applying the virtual teaching scene to real-life settings, including:
transmitting the virtual teaching scene over a network to virtual reality (VR) headsets, thereby immersing learners in a 3D virtual classroom environment. Within the 3D virtual classroom environment, students can interact with virtual objects, including rotating a globe model or operating a virtual microscope for simulated experiments.

In an embodiment, the applying the virtual teaching scene to real-life settings includes:
deploying the virtual teaching scene for real-time rendering via web graphics library (WebGL)-based platforms or using a Unity Engine or an Unreal Engine, and supporting students in accessing and interacting with the virtual teaching scene through web browsers on personal computers, tablets, or mobile phones.

In an embodiment, the applying the virtual teaching scene to real-life settings includes:
integrating the virtual teaching scene into a real-world environment through augmented reality (AR) glasses or mobile AR applications. For example, students can place virtual models of volcanoes or molecular structures on a physical desk and interact with them by walking around or zooming in or zooming out.

In an embodiment, the applying the virtual teaching scene to real-life settings includes:
exporting the virtual teaching scene as a file in formats such as .glb, .gltf, or .fbx for use in offline virtual laboratories, educational simulation systems, or immersive teaching presentations.

In an embodiment, the performing feature extraction on text resources and image resources containing teaching scenes to obtain semantic features, visual features, and sampling features includes:
performing feature extraction on the text resources using a text encoder to obtain the semantic features;
performing feature extraction on the image resources using a visual encoder to obtain the visual features; and
acquiring the 3D positions and the viewing directions of the sampling points in the image resources using a motion structure recovery method, and adding temporal variables to obtain the sampling features.

In an embodiment, before the performing spatial layout encoding and scene hierarchical encoding individually on the 3D teaching resources, performing feature extraction on the 3D teaching resources to obtain spatial point data includes:
selecting and enhancing important feature dimensions in the 3D teaching resources using a channel attention mechanism;
determining key spatial regions in spatial information of the 3D teaching resources using a spatial attention mechanism;
classifying the 3D teaching resources using a classifier to assign different types of resources in the 3D teaching resources to corresponding categories; and
fusing and normalizing outputs of the channel attention mechanism, the spatial attention mechanism, and classifier to obtain the spatial point data, where the spatial point data include spatial positions, category information, and key features of the 3D teaching resources.

In an embodiment, the performing spatial layout encoding and scene hierarchical encoding individually on the 3D teaching resources includes: performing spatial layout encoding on the 3D teaching resources, including the following steps of
capturing attention relationships between spatial points using a spatial attention layer to obtain spatial features;
normalizing the spatial features using a normalization layer to obtain normalized spatial features;
introducing non-linear characteristics to the normalized spatial features using an activation layer to obtain spatial vectors; and
performing graph structure modeling on the spatial vectors using hyperedge constraints to obtain modeled data, and inputting the modeled data into the spatial attention layer, the normalization layer, and the activation layer to obtain the spatial layout features, where the spatial layout features include relative positions, orientations, and sizes of the 3D teaching resources.

In an embodiment, the performing spatial layout encoding and scene hierarchical encoding individually includes performing scene hierarchical encoding on the 3D teaching resources, including the following steps of:
performing feature extraction on spatial points using an initial feature processing module to obtain multiple scene features;
fusing the multiple scene features using a feature fusion module to obtain fused features;
embedding teacher instructions using an embedding module to obtain word vectors;
capturing scene information from the fused features and the word vectors using a long short-term memory network to obtain scene temporal features; and
performing attention weighting on the scene temporal features using an attention mechanism to obtain the hierarchical spatial features, where the hierarchical spatial features include temporal hierarchical orders of the 3D teaching resources and weight allocations of the 3D teaching resources at different times.

In an embodiment, the decoding the spatial layout features and the hierarchical spatial features to obtain geometric shapes and layout position parameters of the 3D teaching resources includes:
performing linear transformation and dimensional adjustment on the spatial layout features and the hierarchical spatial features through an input layer;
performing layer-by-layer decoding on the spatial layout features and the hierarchical spatial features through a layer-by-layer decoding layer, thereby obtaining the geometric shapes and the layout position parameters of the 3D teaching resources as spatial layout information and hierarchical spatial information; and
fusing the spatial layout information and the hierarchical spatial information through a feature fusion layer to obtain unified spatial layout information.

In an embodiment, the rendering parameters include pixel values and volume densities.

In a second aspect, the disclosure provides an apparatus for generating a virtual teaching scene, including:
an extraction module, configured to perform feature extraction on text resources and image resources containing teaching scenes to obtain semantic features, visual features, and sampling features, where the sampling features include 3D positions and viewing directions of sampling points in the image resources, and the 3D positions and the viewing directions varying over time;
a mapping module, configured to map and classify the semantic features, the visual features, and the sampling features to obtain rendering parameters for the virtual teaching scene; and to map the rendering parameters to a 3D space, and to render shapes and surface textures of all objects contained in a virtual classroom in real-time using the rendering parameters, thereby obtaining 3D teaching resources varying over time; and
a generation module, configured to perform spatial layout encoding and scene hierarchical encoding individually on the 3D teaching resources, thereby obtaining spatial layout features representing layout positions of the 3D teaching resources in a 3D scene and hierarchical spatial features representing dynamic evolutions of the 3D teaching resources in the 3D scene; and to decode the spatial layout features and the hierarchical spatial features to obtain geometric shapes and layout position parameters of the 3D teaching resources, and to generate the virtual teaching scene based on the geometric shapes and the layout position parameters of the 3D teaching resources.

In a third aspect, the disclosure provides a computer device. The computer device includes a memory, a processor, and a computer program stored in the memory and executable by the processor, wherein the computer program, when executed by the processor, is configured to implement the method for generating the virtual teaching scene as described above.

In a fourth aspect, the disclosure provides a non-transitory computer-readable storage medium, which is stored with a computer. The computer program, when executed by a processor, is configured to implement the method for generating the virtual teaching scene as described above.

Compared to the related art, the disclosure can achieve the following beneficial effects.

First, the method for generating the virtual teaching scene of the disclosure performs feature extraction on the text resources and the image resources that contain the teaching scenes to obtain the semantic features, the visual features, and the sampling features. The sampling features include the 3D positions and the view directions of the sampling points in the image resources varying over time. Therefore, the features extracted by the disclosure for constructing the 3D teaching resources are dynamic and real-time. These features are then mapped to obtain the rendering parameters for the virtual teaching scene. By using these rendering parameters, the shapes and the surface textures of the all objects contained in the virtual classroom can be rendered in real-time, obtaining the 3D teaching resources varying over time. The 3D teaching resources of the disclosure are dynamically variable and can be adjusted dynamically according to different teaching activities and scenes, significantly enhancing adaptability.

In addition, the spatial layout encoding and the scene hierarchical encoding are performed individually on the 3D teaching resources to obtain encoding results, and the encoding results are decoded to generate the virtual teaching scene. The method for generating the virtual teaching scene of the disclosure effectively utilizes the spatial layout features and the hierarchical spatial features of the 3D teaching resources, enabling the accurate depiction of spatial relationships among multiple objects within the 3D teaching resources, thereby enhancing the precision of the generated teaching scene.

### BRIEF DESCRIPTION OF DRAWINGS

In order to more clearly illustrate technical solutions of embodiments of the disclosure or the related art, attached drawings necessary for the description of the embodiments or the related art will be briefly introduced below. It is apparent that the attached drawings described below are merely some embodiments of the disclosure. For those skilled in the art, other attached drawings can also be obtained from these attached drawings without making inventive efforts.

FIG. 1 illustrates a flowchart of a method for generating a virtual teaching scene according to the disclosure.

FIG. 2 illustrates a structural diagram of a multi-modal neural radiance field model according to the disclosure.

FIG. 3 illustrates a schematic diagram for extracting features of 3D teaching resources according to the disclosure.

FIG. 4 illustrates a structural diagram of a spatial layout encoder according to the disclosure.

FIG. 5 illustrates a structural diagram of a scene hierarchical encoder according to the disclosure.

FIG. 6 illustrates a schematic diagram of the virtual teaching scene generated according to the disclosure.

### DETAILED DESCRIPTION OF EMBODIMENTS

Below, in conjunction with attached drawings in embodiments of the disclosure, a clear and complete description of technical solutions in the embodiments of the disclosure will be provided. It is apparent that the embodiments described are only a part of the embodiments of the disclosure and not all of them. Any and all other embodiments obtained by those skilled in the art without making inventive efforts, based on the embodiments described herein, are within the scope of protection of the disclosure.

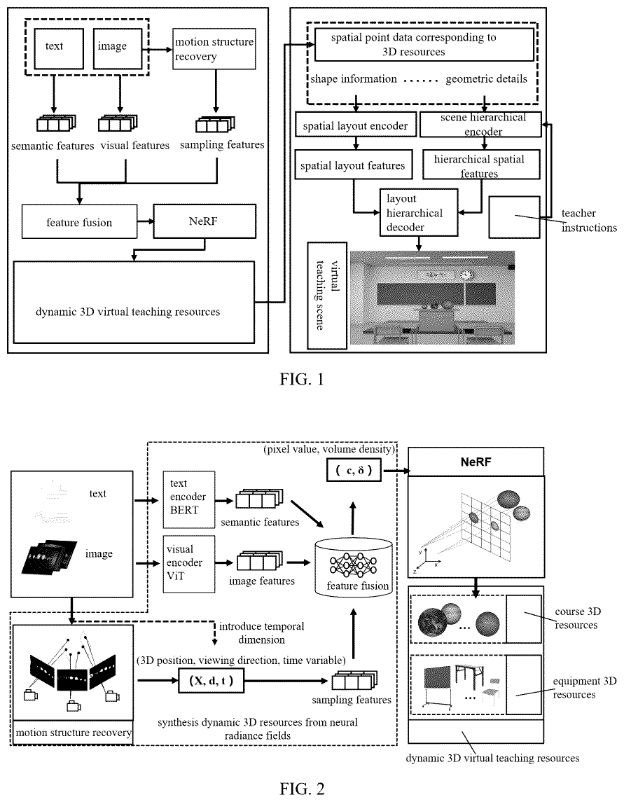

Referring to FIG. 1, the disclosure provides a method for generating a virtual teaching scene. The method uses a multi-modal neural radiance field model and dynamic spatial layout technology to transform text resources and image resources containing teaching scenes into an immersive and interactive 3D virtual teaching environment, thereby enhancing embodied cognitive experience of learners. The method includes the following steps.

S1, feature extraction is performed on the text resources and the image resources containing the teaching scenes to obtain semantic features, visual features, and sampling features.

The text resources and the image resources containing the teaching scenes are obtained from existing knowledge graphs (such as Wikidata and CN-DBpedia), online education platforms (such as National Education Resource Public Service Platform, National Primary and Secondary School Smart Education Platform, and First Lesson Website), or publicly available educational datasets (such as MOOCCube), and the text resources are closely associated with the image resources.

Embodied cognition theory suggests that the learners can deepen their understanding and memory of knowledge through bodily interactive experiences. However, existing methods for generating a dynamic virtual teaching scene in the related art suffer from a disconnect with actual teaching practices, which affects a level of embodied cognition of the learners. Therefore, relying on educational philosophies such as constructivism, the disclosure integrates the semantic features, the visual features, and the sampling features of multi-view images (i.e., the image resources), and introduces a temporal dimension to expand a neural radiance field in space and time. In addition, the multi-modal neural radiance field model is designed to synthesize dynamic 3D virtual teaching resources that possess both immersion and interactivity.

Referring to FIG. 2, first, the multi-modal neural radiance field model converts the text resources and the image resources into the semantic features Fₜ and the visual features Fᵥ containing educational information through a text encoder called bidirectional encoder representations from transformers (BERT) and a visual encoder called vision transformer (ViT), respectively. Here, t represents text, and v represents visual. The semantic features include semantic keywords containing the educational information, vectors of characters and words, vector representations of content topics, part-of-speech tagging, semantic tagging, syntactic tagging, difficulty values, and types of knowledge points, among others. The visual features include colors, shapes, textures, and spatial position information of various objects.

Then, 3D positions X and viewing directions d of sampling points in the image resources are analyzed using a motion structure recovery method, and temporal variables t are added to extend the neural radiance field to a spatiotemporal domain. By predicting displacements of each spatial point at different times using a formula ΔXₜ=φ(Xₜ, t), the 3D teaching resources are enabled to dynamically vary over time. This dynamic characteristic facilitates the internalization of knowledge and enhances long-term memory in the learners.

In an embodiment, the sampling points refer to 3D spatial positions in the image resources that are associated with the virtual scene, which are used to describe spatial information of the image resources. The sampling features are extracted from information of the sampling points in the image resources, and the sampling features include visual data and spatial data related to the educational information within the scene. Specifically, the sampling features include the 3D positions X, the viewing directions d, and the temporal variables t. These data help form dynamic change information of each of the sampling points at different times in the virtual teaching scene. These sampling features are integrated into the neural radiance field to generate 3D teaching resources with spatiotemporal dynamics, thereby enhancing the immersive experience and long-term memory of the learners. The motion structure recovery method is a computer vision technology used to recover a 3D structure of the scene and camera motion information from image or video sequences. This method is commonly used to the modeling of dynamic scenes, and is particularly effective in reconstructing the 3D information of objects or scenes when dealing with factors such as object motion and changes in viewing angles.

S2, the semantic features, the visual features, and the sampling features are mapped and classified to obtain rendering parameters for the virtual teaching scene.

The sampling features Fₛ, the semantic features Fₜ and the visual features Fᵥ are jointly used as multimodal features and input into a fully connected layer. The fully connected layer performs mapping and classification on the multimodal features to output pixel values c and volume densities δ.

S3, the rendering parameters are mapped to a 3D space, and shapes and surface textures of all objects contained in a virtual classroom are rendered to obtain 3D teaching resources varying over time.

To solve a problem of lower rendering efficiency for dynamic 3D resources, a method based on neural radiance fields (NeRF) is used, which maps the pixel values and the volume densities to the 3D space. The NeRF method enables efficient generation of the dynamic 3D teaching resources and supports dynamic changes in the temporal dimension. The learners can interact with the virtual scene by autonomously clicking on the dynamic 3D resources to gain a deeper understanding of the displayed and explained knowledge points, thereby aligning with the constructivist theory that the learners actively construct their own knowledge.

Compared to traditional static 3D rendering methods, the NeRF method can utilize advantages of volumetric rendering to maintain high-quality visual effects in the dynamic scenes. For example, in the virtual teaching scene, objects (such as interactive teaching aids and educational equipment) can be dynamically adjusted based on time, changes in viewpoint, or learner interactions. The NeRF method not only enhances the real-time rendering and visual immersion but also strengthens the ability of the learners to internalize knowledge and improves learning outcomes through interactive learning methods.

In the embodiment, equipment 3D resources include various static objects found in a classroom, such as desks, chairs, blackboards, desk-chair sets, clocks, and podiums. The course 3D resources are dynamic teaching elements directly related to the course content, which are not limited to static objects but are dynamically generated based on different teaching materials. For example, the course 3D resources include models of the Earth and microscopes. If the teaching content involves knowledge related to the Earth or geography, a system generates a 3D model of the Earth based on the course content for a teacher to display, explain, and interact with in the virtual classroom. For chemistry courses, if experiments or explanations of microscope usage are required, the system generates a 3D microscope model based on the teaching content, which the teacher can use as a teaching resource for demonstration and manipulation. By combining the podium and course resources, a teaching region is created. These dynamically generated 3D resources can be flexibly provided according to the different needs of the course, assisting teachers in conducting vivid teaching presentations and enhancing students'interactivity and immersion.

To stimulate enthusiasm of the learners for learning and foster their innovative thinking, the disclosure focuses on arranging teaching resources within a virtual teaching space, aiming to create a diverse and content-rich virtual teaching environment. Therefore, by integrating teacher instructions, such as teaching modes, a virtual teaching scene generation model is designed. By optimizing the layout of the teaching resources in the virtual teaching space, a more immersive and spatially 3D virtual teaching scene is generated.

S4, feature extraction is performed on the 3D teaching resources to obtain unified feature vectors that includes spatial positions, category information, and key features of the 3D teaching resources, providing input data for a subsequent spatial layout encoder.

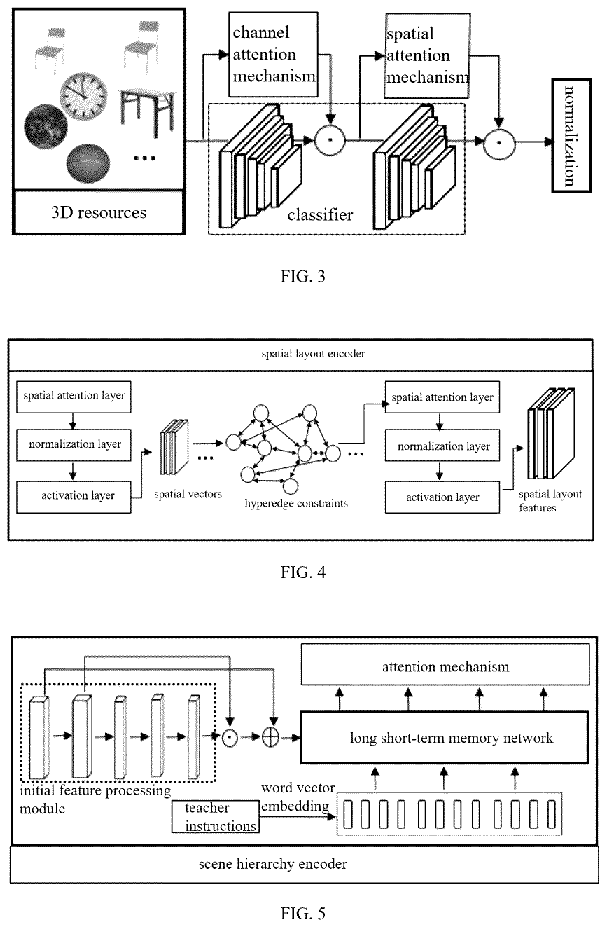

Referring to FIG. 3, in a treatment process for the 3D teaching resources, a channel attention mechanism, a spatial attention mechanism, and a classifier are used to extract and classify the features of the 3D teaching resources. Subsequently, the unified feature vectors are generated through feature fusion and a normalization operation.

By using the channel attention mechanism to select and enhance important feature dimensions in 3D resource data, different feature channels of the 3D resources (such as color, texture, size, etc.) are identified to determine which channels are more important for a current task, thereby enhancing the representation ability of key features. For example, in the 3D teaching resources, important feature channels may include a black writing region of the blackboard (color channel), the wooden texture of the desks (texture channel), and a relative size of the globe compared to other objects (size channel). These features play a crucial role in the accurate identification and spatial arrangement of virtual teaching objects. The channel attention mechanism ensures that the virtual teaching scene generation model focuses on the most relevant features when processing the 3D resource data. By using the spatial attention mechanism to determine important spatial positions in spatial information of the 3D resources. Through the spatial attention mechanism, the virtual teaching scene generation model can identify key spatial regions in the 3D resources, such as a seat cushion of a chair, a tabletop region of a table, etc. This mechanism helps the virtual teaching scene generation model extract important spatial information of each resource, providing support for subsequent layout. The classifier is used to categorize the 3D resources, assigning different types of the 3D resources to their respective categories. For example, the chairs, the desks, and the clocks are classified into different types. By classifying the 3D resources, the model can distinguish functions and usage scenes of different 3D resources. For example, the chairs and the desks are part of the regular classroom setup, while models of the Earth or the microscopes belong to course resources. An output of the classifier guides subsequent spatial layout and scene construction. The features extracted by the channel attention mechanism and the spatial attention mechanism are fused to form a unified feature representation for each resource. After feature fusion, the normalization operation (such as standardization or batch normalization) is used to adjust the scale of features, ensuring the stability of feature distribution, which is beneficial for subsequent spatial layout prediction. The output spatial point data include the following key information for the 3D resources: spatial positions, category information (such as the functional type of the resource: chairs, desks, and experimental models, etc.), and key features (such as texture, material, and geometric shape, etc.). The spatial point data provide input for a spatial layout encoder to guide the rational arrangement of resources in the virtual scene.

In an embodiment, each of the channel attention mechanism, the spatial attention mechanism, and the classifier is embodied by at least one processor and at least one memory coupled to the at least one processor, and the at least one memory stores computer programs executable by the at least one processor.

S5, the spatial point data are input into the virtual teaching scene construction model to perform spatial layout encoding and scene hierarchical encoding individually to obtain spatial layout features and hierarchical spatial features, the spatial layout features and the hierarchical spatial features are decoded to obtain geometric shapes and layout position parameters of the 3D teaching resources, and the virtual teaching scene is generated based on the geometric shapes and the layout position parameters of the 3D teaching resources.

The virtual teaching scene construction model includes three core modules: a spatial layout encoder, a scene hierarchy encoder, and a layout hierarchy decoder. The spatial layout encoder takes the spatial points data from the 3D teaching resources as an input, extracting the spatial layout features to predict layout positions of the 3D resources. In addition to considering horizontal and vertical edge constraints of the 3D teaching resources, the spatial layout encoder also implements multi-relationship encoding between multiple resources based on hyperedge constraints to ensure that the spatial layout aligns more closely with the cognitive characteristics and patterns of the learners, thereby reducing the cognitive load on the learners.

In an embodiment, each of the spatial layout encoder, the scene hierarchy encoder, and the layout hierarchy decoder is embodied by at least one processor and at least one memory coupled to the at least one processor, and the at least one memory stores computer programs executable by the at least one processor.

Referring to FIG. 4, the spatial layout encoder includes a spatial attention layer, a normalization layer, an activation layer, and hyperedge constraints.

The spatial attention layer is used to capture attention relationships between spatial points, thereby enhancing the representational capacity of significant spatial features. Through the attention mechanism, it identifies and focuses on spatial positions within the scene that possess importance or priority, ensuring the rationality and coordination of resources during the layout process.

The normalization layer normalizes the spatial features to ensure a stable distribution of the features within the network, reducing the risk of vanishing or exploding gradients. By performing the normalization operation, the distribution of features between different layers is stabilized, thereby improving the training effectiveness and convergence rate of the model.

The activation layer uses a leaky rectified linear unit (LeakyReLU) activation function to endow the network with nonlinear characteristics, enabling it to better fit complex spatial layout relationships. LeakyReLU is capable of handling negative values, thereby preserving the information of negative features, which helps the model in learning more intricate spatial relationships.

Following processing through the attention layer, the normalization layer, and the activation layer, spatial vectors are generated to represent spatial positions and orientations of the teaching resources.

The hyperedge constraint models the spatial vectors through graph structure, incorporating “hyperedge” constraint relationships among multiple resources. The hyperedge constraints refer to establishing multiple associations between the different resources to ensure the rationality of the resource layout and the consistency of their interrelationships.

After generating preliminary spatial vectors, they are further processed through the spatial attention layer, the normalization layer, and the LeakyReLU activation to refine the spatial features. Through repeated attention mechanisms and feature extraction, the encoder is capable of capturing more nuanced spatial relationships and generating more hierarchical spatial layout features.

Following the aforementioned processing, the resulting spatial layout features are used to indicate the specific layout positions of resources within a three-dimensional scene. These features may include information such as the relative positions, orientations, and sizes of the resources to ensure that the generated virtual teaching scenario is laid out in a logical manner.

In an embodiment, each of the spatial attention layer, the normalization layer, the activation layer, and the hyperedge constraints is embodied by at least one processor and at least one memory coupled to the at least one processor, and the at least one memory stores computer programs executable by the at least one processor.

Within a framework of the embodied cognition theory, the teaching process is no longer merely the transmission of knowledge but gradually evolves into an integration of experience and perception over time. Therefore, the generation of dynamic 3D scene sequences aids in guiding learners to deepen their cognitive understanding progressively. The disclosure is dedicated to generating dynamic 3D scene sequence models based on the teaching design within the virtual classroom, promoting the development of embodied cognition by creating interactive teaching tasks and activities, such as teaching simulation experiments, ensuring that the presentation of different virtual scenes is in harmony with the teaching process.

In the scene hierarchy encoder, the module encodes the 3D resources at multiple levels using a variational autoencoder, recursively mapping them into the scene space in a layered fashion. Referring to FIG. 5, the scene hierarchy encoder includes an initial feature processing module, a feature fusion module, an embedding module, a long short-term memory network, and an attention mechanism.

The initial feature processing module includes a convolutional layer (COV), residual connections (Res), a feature extraction layer (CAP), a fully connected layer (FC), rectified linear unit (ReLU), and Sigmoid. Features of the input data are extracted to obtain multiple scene features.

The COV is configured to extract spatial features from the input data. The Res is configured to prevent the vanishing gradient problem, ensuring that features are not lost during multi-layer transmission. The CAP is configured to further extract high-level features. The FC is configured to transform the feature vectors into an output of a specified dimension. The ReLU refers to a ReLU activation function, introducing the nonlinear characteristics to the model. The Sigmoid refers to a Sigmoid activation function, configured to map values of the features to a range (0,1).

The feature fusion module is configured to integrate features extracted from different layers through addition and element-wise multiplication to generate a more comprehensive feature representation, known as fused features.

In the embedding module, the teacher instructions are embedded into word vectors, serving as additional input information. The word vector embedding transforms the specific instructions of the teacher (e.g., teaching content or objectives) into a feature representation that the model can comprehend.

Multiple scene-level Long Short-Term Memory (S-LSTM) modules are used to encode temporal features to obtain scene temporal features. The S-LSTM is configured to effectively capturing dynamic changes and hierarchical structures within the scene. The design of multi-layer S-LSTM assists the model in capturing and retaining significant scene information across various time steps.

The attention mechanism is configured to focus on significant positions or objects within the scene, applying attention weighting to the scene temporal features to obtain the hierarchical spatial features that characterize the dynamic evolutions of the 3D teaching resources within the 3D scene. The hierarchical spatial features include the temporal orders of the 3D resources and weight allocations to different teaching resources at various times, ensuring that the generated virtual teaching scene meets educational requirements. The attention mechanism can assist the model in concentrating on key content or resources mentioned in the teacher instructions and prioritize these elements during layout generation.

In an embodiment, each of the feature fusion module, the embedding module, the long short-term memory network, and the attention mechanism is embodied by at least one processor and at least one memory coupled to the at least one processor, and the at least one memory stores computer programs executable by the at least one processor.

Finally, the layout hierarchy decoder decodes the spatial layout encoding and the scene hierarchical encoding from top to down into fine-grained geometric shapes and layout position parameters of the 3D teaching resources.

The layout hierarchy decoder includes an input layer, a layer-by-layer decoding layer, and a feature fusion layer.

Input layer: the spatial layout features from the spatial layout encoder and the hierarchical spatial features from the scene hierarchy encoder are input into the input layer. These input data undergo simple linear transformation and dimensional adjustment before entering the decoder to ensure that the features are properly processed during decoding. The purpose of this step is to standardize the input features, making them suitable for subsequent decoding and fusion processes.

Layer-by-layer decoding layer: in the layer-by-layer decoding layer, the layout hierarchy decoder progressively decodes the input features according to a hierarchical structure to obtain high-level global layout information as well as fine-grained local geometric parameters. The decoder initially generates the geometric shapes (such as cylinders, rectangles, etc.) of the 3D teaching resources, and sizes, orientations, and 3D positional parameters of the 3D teaching resources (i.e., the layout position parameters of the 3D teaching resources). This process ensures that the layout of each resource has a sense of hierarchy and consistency, progressively refining from global information to local spatial details, guaranteeing an accurate and rational distribution of resources within the virtual scene.

Feature fusion layer: following the layer-by-layer decoding, the feature fusion layer integrates features from the spatial layout encoder and the scene hierarchy encoder to generate unified spatial layout information. Through feature fusion, the decoder combines spatial layout information with hierarchical spatial information, ensuring that the distribution and relative positional relationships of resources in space remain consistent and aligned with educational objectives. The fused features further adjust the spatial positioning of resources and dynamically modify the layout of resources based on temporal information, ensuring that over time, the resources within the virtual teaching scenario can change reasonably in terms of layout and sequence, thereby enhancing the interactivity and depth of the teaching process.

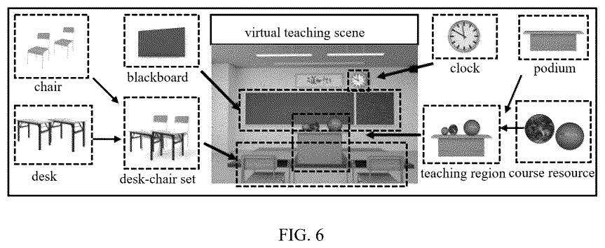

Application to scene generation: these decoding results are used for the final rendering of the virtual teaching scene, as shown in FIG. 6, ensuring that each teaching resource is accurately placed within the virtual environment to enhance the effectiveness of instruction and the interactive experience of learners.

In an embodiment, each of the input layer, the layer-by-layer decoding layer, and the feature fusion layer is embodied by at least one processor and at least one memory coupled to the at least one processor, and the at least one memory stores computer programs executable by the at least one processor.

Compared to the existing methods for generating the virtual scene, the virtual teaching scene layout model proposed by the disclosure effectively utilizes the spatial positional hierarchy of the 3D teaching resources and the multifaceted contextual relationships between resources. It addresses the problem of spatial layout being disconnected from actual teaching practices, generating a virtual teaching scene with rational layouts, and promoting the embodied cognitive development and immersive learning of the learners.

Based on the same concept, the disclosure further provides an apparatus for generating a virtual teaching scene, including an extraction module, a mapping module, and a generation module.

The extraction module is configured to perform feature extraction on text resources and image resources containing teaching scenes to obtain semantic features, visual features, and sampling features. The sampling features include 3D positions and viewing directions of the sampling points in the image resources, and the 3D positions and the viewing directions varying over time.

The mapping module is configured to map and classify the semantic features, the visual features, and the sampling features to obtain rendering parameters for the virtual teaching scene. The rendering parameters are then mapped to a 3D space. By using the rendering parameters, shapes and surface textures of all objects contained in a virtual classroom are rendered in real-time, thereby obtaining 3D teaching resources varying over time.

The generation module is configured to perform spatial layout encoding and scene hierarchical encoding on the 3D teaching resources individually, thereby obtaining spatial layout features that represent layout positions of the 3D teaching resources in a 3D scene and hierarchical spatial features that represent dynamic evolutions of the 3D teaching resources in the 3D scene. By decoding the spatial layout features and the hierarchical spatial features, geometric shapes and layout position parameters of the 3D teaching resources are obtained. The virtual teaching scene is generated based on the geometric shapes and the layout position parameters of the 3D teaching resources.

In an embodiment, each of the extraction module, the mapping module, and the generation module is embodied by at least one processor and at least one memory coupled to the at least one processor, and the at least one memory stores computer programs executable by the at least one processor.

The disclosure still provides a computer device, which includes a memory, a processor, and a computer program stored in the memory and executable by the processor. The computer program, when executed by the processor, is configured to implement the method for generating the virtual teaching scene as described above.

The disclosure even still provides a computer-readable storage medium, which is a non-transitory computer-readable storage medium. The computer-readable storage medium is stored with a computer program. The computer program, when executed by a processor, is configured to implement the method for generating the virtual teaching scene as described above.

Although specific embodiments of the disclosure have been described, those skilled in the art, upon grasping the fundamental inventive concept, will recognize that various modifications and changes may be made to these embodiments. Accordingly, the appended claims are intended to be interpreted as covering the described specific embodiments and all modifications and changes that fall within the scope of the disclosure.

It is apparent that those skilled in the art can make various modifications and variations to the disclosure without departing from the spirit and scope of the disclosure. Thus, if these modifications and variations fall within the scope of the appended claims and their equivalents, the disclosure is also intended to include such modifications and variations.

What is claimed is:

1. A method for generating a virtual teaching scene, comprising:
performing feature extraction on text resources and image resources containing teaching scenes to obtain semantic features, visual features, and sampling features, wherein the sampling features comprise three-dimensional (3D) positions and viewing directions of sampling points in the image resources, and the 3D positions and the viewing directions varying over time;
mapping and classifying the semantic features, the visual features, and the sampling features to obtain rendering parameters for the virtual teaching scene; and mapping the rendering parameters to a 3D space, and rendering shapes and surface textures of all objects contained in a virtual classroom in real-time using the rendering parameters, thereby obtaining 3D teaching resources varying over time; and
performing spatial layout encoding and scene hierarchical encoding individually on the 3D teaching resources, thereby obtaining spatial layout features representing layout positions of the 3D teaching resources in a 3D scene and hierarchical spatial features representing dynamic evolutions of the 3D teaching resources in the 3D scene; and decoding the spatial layout features and the hierarchical spatial features to obtain geometric shapes and layout position parameters of the 3D teaching resources, and generating the virtual teaching scene based on the geometric shapes and the layout position parameters of the 3D teaching resources.

2. The method for generating the virtual teaching scene as claimed in claim 1, wherein the performing feature extraction on text resources and image resources containing teaching scenes to obtain semantic features, visual features, and sampling features comprises:
performing feature extraction on the text resources using a text encoder to obtain the semantic features;
performing feature extraction on the image resources using a visual encoder to obtain the visual features; and
acquiring the 3D positions and the viewing directions of the sampling points in the image resources using a motion structure recovery method, and adding temporal variables to obtain the sampling features.

3. The method for generating the virtual teaching scene as claimed in claim 1, further comprising:
before the performing spatial layout encoding and scene hierarchical encoding individually on the 3D teaching resources, performing feature extraction on the 3D teaching resources to obtain spatial point data, wherein the performing feature extraction on the 3D teaching resources to obtain the spatial point data comprises:
selecting and enhancing important feature dimensions in the 3D teaching resources using a channel attention mechanism;
determining key spatial regions in spatial information of the 3D teaching resources using a spatial attention mechanism;
classifying the 3D teaching resources using a classifier to assign different types of resources in the 3D teaching resources to corresponding categories; and
fusing and normalizing outputs of the channel attention mechanism, the spatial attention mechanism, and the classifier to obtain the spatial point data, wherein the spatial point data comprise spatial positions, category information, and key features of the 3D teaching resources.

4. The method for generating the virtual teaching scene as claimed in claim 3, wherein the performing spatial layout encoding and scene hierarchical encoding individually on the 3D teaching resources comprises performing spatial layout encoding on the 3D teaching resources, comprising the following steps of:
capturing attention relationships between spatial points using a spatial attention layer to obtain spatial features;
normalizing the spatial features using a normalization layer to obtain normalized spatial features;
introducing non-linear characteristics to the normalized spatial features using an activation layer to obtain spatial vectors; and
performing graph structure modeling on the spatial vectors using hyperedge constraints to obtain modeled data, and inputting the modeled data into the spatial attention layer, the normalization layer, and the activation layer to obtain the spatial layout features, wherein the spatial layout features comprise relative positions, orientations, and sizes of the 3D teaching resources.

5. The method for generating the virtual teaching scene as claimed in claim 3, wherein the performing spatial layout encoding and scene hierarchical encoding individually comprises performing scene hierarchical encoding on the 3D teaching resources, comprising the following steps of:
performing feature extraction on spatial points using an initial feature processing module to obtain multiple scene features;
fusing the multiple scene features using a feature fusion module to obtain fused features;
embedding teacher instructions using an embedding module to obtain word vectors;
capturing scene information from the fused features and the word vectors using a long short-term memory network to obtain scene temporal features; and
performing attention weighting on the scene temporal features using an attention mechanism to obtain the hierarchical spatial features, wherein the hierarchical spatial features comprise temporal hierarchical orders of the 3D teaching resources and weight allocations of the 3D teaching resources at different times.

6. The method for generating the virtual teaching scene as claimed in claim 5, wherein the decoding the spatial layout features and the hierarchical spatial features to obtain geometric shapes and layout position parameters of the 3D teaching resources comprises:
performing linear transformation and dimensional adjustment on the spatial layout features and hierarchical spatial features through an input layer;
performing layer-by-layer decoding on the spatial layout features and the hierarchical spatial features through a layer-by-layer decoding layer, thereby obtaining the geometric shapes and the layout position parameters of the 3D teaching resources as spatial layout information and hierarchical spatial information; and
fusing the spatial layout information and the hierarchical spatial information through a feature fusion layer to obtain unified spatial layout information.

7. The method for generating the virtual teaching scene as claimed in claim 1, wherein the rendering parameters comprise pixel values and volume densities.

8. An apparatus for generating a virtual teaching scene, comprising:
an extraction module, configured to perform feature extraction on text resources and image resources containing teaching scenes to obtain semantic features, visual features, and sampling features, wherein the sampling features comprise 3D positions and viewing directions of sampling points in the image resources, and the 3D positions and the viewing directions varying over time;
a mapping module, configured to map and classify the semantic features, the visual features, and the sampling features to obtain rendering parameters for the virtual teaching scene; and to map the rendering parameters to a 3D space, and to render shapes and surface textures of all objects contained in a virtual classroom in real-time using the rendering parameters, thereby obtaining 3D teaching resources varying over time; and
a generation module, configured to perform spatial layout encoding and scene hierarchical encoding individually on the 3D teaching resources, thereby obtaining spatial layout features representing layout positions of the 3D teaching resources in a 3D scene and hierarchical spatial features representing dynamic evolutions of the 3D teaching resources in the 3D scene; and to decode the spatial layout features and the hierarchical spatial features to obtain geometric shapes and layout position parameters of the 3D teaching resources, and to generate the virtual teaching scene based on the geometric shapes and the layout position parameters of the 3D teaching resources.

9. A computer device, comprising a memory, a processor, and a computer program stored in the memory and executable by the processor, wherein the computer program, when executed by the processor, is configured to implement the method for generating the virtual teaching scene as claimed in claim 1.

10. A non-transitory computer-readable storage medium, stored with a computer program, wherein the computer program, when executed by a processor, is configured to implement the method for generating the virtual teaching scene as claimed in claim 1.
